(19) United States
(12) Patent Application Publication
(10) Pub. No.: US 2015/0081757 A1
(43) Pub. Date: Mar. 19, 2015

(54) INFORMATION PROCESSING SYSTEM AND INFORMATION PROCESSING METHOD

(71) Applicant: Atsuko YAGI, Kanagawa (JP)

(72) Inventor: Atsuko YAGI, Kanagawa (JP)

(73) Assignee: Ricoh Company, Limited, Tokyo (JP)

(21) Appl. No.: 14/484,766

(22) Filed: Sep. 12, 2014

(30) Foreign Application Priority Data
Sep. 17, 2013 (JP) 2013-192407

(51) Int. Cl. H04L 29/08

(52) U.S. Cl. CPC H04L 67/1002
USPC 709/201

(57) ABSTRACT

An information processing system includes an information acquiring apparatus for acquiring data and a server, and executes multiple processes defined in workflow information. The workflow information defines order of the multiple processes. Either the information acquiring apparatus or the server performs the multiple processes defined in the workflow information. When a specific process is included in the multiple processes defined in the workflow information, the information acquiring apparatus transmits target data to the server before the specific process. The server receives the target data, and performs the specific process out of the multiple processes defined in the workflow information.

### CROSS-REFERENCE TO RELATED APPLICATIONS

The present application claims priority to and incorporates by reference the entire contents of Japanese Patent Application No. 2013-192407 filed in Japan on Sep. 17, 2013.

### BACKGROUND OF THE INVENTION

1. Field of the Invention

The present invention relates to an information processing system and information processing method for performing multiple processes.

2. Description of the Related Art

Conventionally, a multifunction peripheral (MFP) with functions of a printer, a scanner, and a facsimile machine, etc. has a function of executing a workflow, which defines procedures of multiple processes in advance, on image data captured by the scanner or the like (for example, see Japanese Patent Application Laid-open No. 2008-097586). By defining the workflow, the MFP can automatically transmit the captured image data to a specified folder or automatically transmit the captured image data by e-mail.

Furthermore, there is also known a system in which a server executes a workflow. In this system, an MFP transmits captured image data to the server, and the server performs multiple processes defined in the workflow. According to this system, it is possible to execute the workflow including processes which are difficult for the MFP to perform (for example, an image correction process and a character recognition process, etc.).

By the way, conventionally, an apparatus which executes a workflow is either an MFP or a server. However, in recent years, an MFP has improved in function, and therefore can perform even a relatively highly-loaded process. Accordingly, it is hoped that the MFP and the server execute the workflow efficiently.

Therefore, there is a need for an information processing system and information processing method capable of performing multiple processes defined in workflow information efficiently.

### SUMMARY OF THE INVENTION

It is an object of the present invention to at least partially solve the problems in the conventional technology.

The present invention provides an information processing system that includes an information acquiring apparatus for acquiring data and a server and executes multiple processes defined in workflow information. The workflow information defines order of the multiple processes, either the information acquiring apparatus or the server performs the multiple processes defined in the workflow information, when a specific process is included in the multiple processes defined in the workflow information, the information acquiring apparatus transmits target data to the server before the specific process, and the server receives the target data and performs the specific process out of the multiple processes defined in the workflow information.

The present invention also provides an information processing method employed in an information processing system that includes an information acquiring apparatus for acquiring data and a server and executes multiple processes defined in workflow information, the workflow information defining order of the multiple processes. The method includes: performing, at either the information acquiring apparatus or the server, the multiple processes defined in the workflow information, wherein the performing further includes; transmitting, at the information acquiring apparatus, target data to the server before the specific process, when a specific process is included in the multiple processes defined in the workflow information; receiving, at the server, the target data; and performing, at the server, the specific process out of the multiple processes defined in the workflow information. The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram showing a configuration of an information processing system according to an embodiment;

FIG. 2 is a diagram showing a relationship between multiple processes performed in the information processing system and a process executing body;

FIG. 3 is a diagram showing functional configurations of an MFP and a workflow server;

FIG. 4 is a diagram showing an example of setting information included in workflow information;

FIG. 5 is a diagram showing a sequence of workflow execution;

FIG. 6 is a flowchart in the case where first, an executing body is determined, and then a workflow is executed by the determined executing body;

FIG. 7 is a diagram showing an example of setting information (plug-in information) of each process included in workflow information;

FIG. 8 is a flowchart in the case where an executing body is determined with respect to each process, and a workflow is executed by the determined executing body;

FIG. 9 is a flowchart in the case where first, an executing body is determined on the basis of the number of job queues, and then a workflow is executed by the determined executing body;

FIG. 10 is a flowchart in the case where an executing body is determined on the basis of the number of job queues with respect to each process, and a workflow is executed by the determined executing body;

FIG. 11 is a flowchart in the case of switching to either to execute a flow of determining an executing body first or to execute a flow of determining an executing body with respect to each process on the basis of the number of job queues;

FIG. 12 is a flowchart in the case of executing a workflow including a process that the workflow server cannot perform;

FIG. 13 is a diagram showing functional configurations of an MFP and a workflow server which are included in an information processing system according to a variant;

FIG. 14 is a diagram showing an example of setting information (plug-in information) of each process included in workflow information according to the variant;

FIG. 15 is a diagram showing an example of device information indicating capability that an apparatus has;

FIG. 16 is a diagram showing another example of device information indicating capability that an apparatus has;

FIG. 17 is a flowchart in the case where in the information processing system according to the variant, an executing body is determined with respect to each process, and a workflow is executed;

FIG. 18 is a flowchart in the case where in the information processing system according to the variant, first, an executing body is determined, and then a workflow is executed;

FIG. 19 is a diagram showing a configuration in which the information processing system according to the embodiment is applied to a cloud system;

FIG. 20 is a diagram showing an example of a hardware configuration of the MFP; and

FIG. 21 is a diagram showing an example of a hardware configuration of the workflow server.

### DETAILED DESCRIPTION OF THE PREFERRED EMBODIMENTS

An exemplary embodiment of the present invention will be explained in detail below with reference to accompanying drawings. Incidentally, the present invention is not limited to this embodiment.

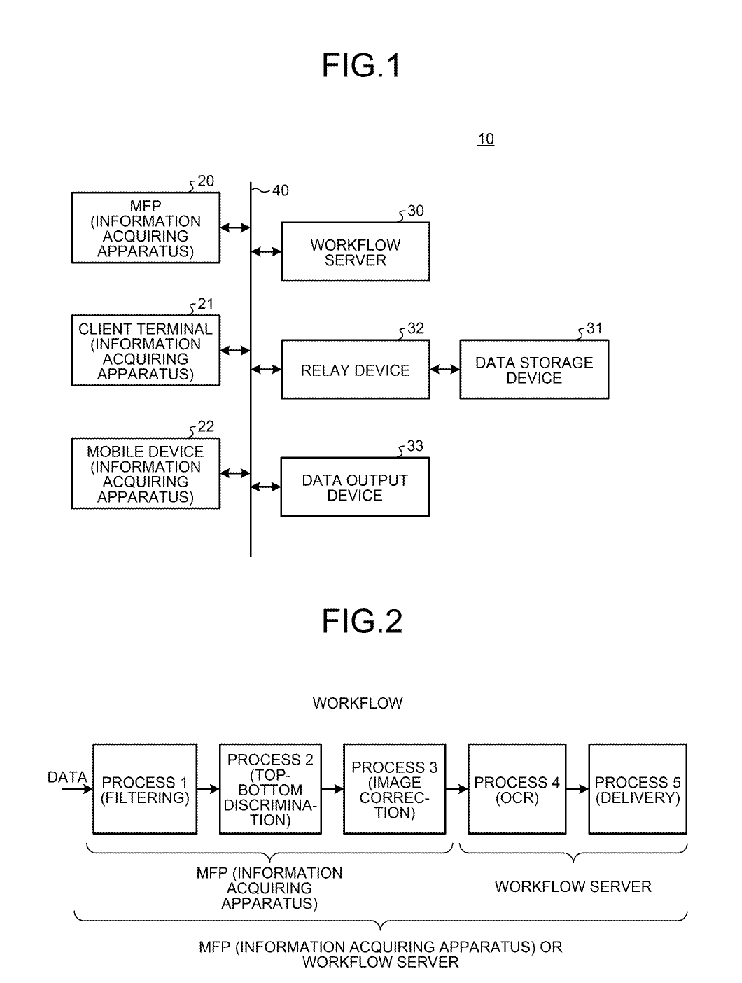

FIG. 1 is a diagram showing a configuration of an information processing system 10 according to the embodiment. The information processing system 10 includes, for example, a multifunction peripheral (MFP) 20, a client terminal 21, a mobile device 22, a workflow server 30, a data storage device 31, a relay device 32, and a data output device 33.

The MFP 20, the client terminal 21, the mobile device 22, the workflow server 30, the relay device 32, and the data output device 33 are connected via a network 40. Furthermore, the data storage device 31 is connected to the network 40 through the relay device 32. Alternatively, the data storage device 31 can be directly connected to the network 40.

The network 40 can be a local area network (LAN) or a wide area network (WAN) connected with a LAN through a router. Furthermore, the network 40 can include the Internet and a telephone communication line, etc. Moreover, the network 40 can be composed of a wired network, or a part or whole of the network 40 can be composed of a wireless network.

The MFP 20 has at least one of a scanner function and a facsimile machine function, and works as an information acquiring apparatus that acquires data. Besides, the MFP 20 further has a communication function and a display function, etc. Furthermore, the MFP 20 has stored therein a program in advance, and works as an information processing apparatus that performs data processing in accordance with the program. As an example, the MFP 20 scans a sheet, thereby capturing image data, and performs data processing on the captured image data in accordance with the program.

The client terminal 21 is a desktop computer, a notebook computer, a workstation, or an electronic blackboard, etc. The client terminal 21 is an information acquiring apparatus that acquires information by image pickup, voice input, information input from a communication medium, and information readout from a storage medium, etc. Furthermore, the client terminal 21 has a communication function and a display function, etc. Moreover, the client terminal 21 has stored therein a program in advance, and works as an information processing apparatus that performs data processing in accordance with the program.

The mobile device 22 is a device such as a smartphone, a tablet terminal, a cell-phone, or a digital camera that a user carries. The mobile device 22 is an information acquiring apparatus that acquires information by image pickup, voice input, information input from a communication medium, or information readout from a storage medium, etc. Furthermore, the mobile device 22 has a communication function and a display function, etc. Moreover, the mobile device 22 has stored therein a program in advance, and works as an information processing apparatus that performs data processing in accordance with the program.

Incidentally, the MFP 20, the client terminal 21, and the mobile device 22 can request the workflow server 30 to execute a workflow. The information processing system 10 can include an information acquiring apparatus other than the MFP 20, the client terminal 21, and the mobile device 22.

The workflow server 30 is composed of one or more computers. The workflow server 30 has a communication function, and has stored therein a program in advance and works as an information processing apparatus that performs data processing in accordance with the program.

The workflow server 30 has stored therein workflow information in advance. The workflow information is information which defines an order of multiple processes. Information processing apparatus which constitutes a workflow executing body here is the workflow server 30 and an information acquiring apparatus (for example, the MFP 20, the client terminal 21, or the mobile device 22) that requests the workflow server 30 to execute a workflow via the network 40.

The workflow server 30 provides requested workflow information to an information acquiring apparatus (the MFP 20, the client terminal 21, or the mobile device 22) which has requested execution of a workflow. Then, the workflow server 30 performs multiple processes defined in the workflow information together with the information acquiring apparatus which has requested execution of the workflow. More specifically, either the workflow server 30 or the information acquiring apparatus, which has requested execution of the workflow, performs each of the multiple processes defined in the workflow information in the defined order. When the executing body is changed, the workflow server 30 and the information acquiring apparatus, which has requested execution of the workflow, transfer target data to be processed to a new executing body via the network 40.

The data storage device 31 is composed of one or more computers. The data storage device 31 has a communication function and an information storage function. The data storage device 31 is, for example, a file server or a mail server, etc. The data storage device 31 receives data which is a result of workflow execution from the workflow server 30 or an information acquiring apparatus (for example, the MFP 20, the client terminal 21, or the mobile device 22), and stores the received data inside thereof.

The relay device 32 relays data transfer between the workflow server 30 or an information acquiring apparatus (for example, the MFP 20, the client terminal 21, or the mobile device 22) and the data storage device 31.

The data output device 33 has a communication function and an information output function. The data output device 33 is, for example, a display device, a printer, a projector, an electronic blackboard, or a voice output device, etc. The data output device 33 receives data which is a result of workflow execution from the workflow server 30 or an information acquiring apparatus (for example, the MFP 20, the client terminal 21, or the mobile device 22), and outputs the received data to the outside. The data output device 33 can be integrally formed with an information acquiring apparatus (for example, the MFP 20, the client terminal 21, or the mobile device 22).

In the information processing system 10, the workflow server 30 and the MFP 20, the client terminal 21, or the mobile device 22, which has been provided with workflow information, perform multiple processes defined in the workflow information.

There is described below an example where the workflow server 30 and the MFP 20 perform multiple processes in cooperation.

FIG. 2 is a diagram showing a relationship between multiple processes performed in the information processing system 10 and a process executing body. Contents and executing order of the multiple processes are defined in workflow information. The workflow information is written in a computer-interpretable data format. For example, the workflow information is written in XML (Extensible Markup Language).

The workflow information can define, for example, various data processing (a data compression process, a character recognition process (OCR), a filtering process, a data synthesis process, a process of encoding data into a specific data format, and a process of converting data into a specific data format (for example, PDF format), etc.). Furthermore, the workflow information can define, for example, a process of outputting data to the outside (a printing process, a displaying process, a voice output process, a process of delivering (uploading) data to a server, and a mail delivery process, etc.). Moreover, the workflow information can also define, for example, a data capturing process (for example, a scanning process, an image pickup process, a mail receiving process, and a facsimile receiving process, etc.)

Furthermore, the order of executing processes is defined in the workflow information. Each apparatus which performs a process receives target data which is a result of the preceding process, and performs the process on the received target data.

The target data to be processed in the workflow is, for example, image data. Besides this, the target data to be processed can be any data, such as moving image data, text data, voice data, and a computer program.

In the information processing system 10, some of the multiple processes defined in the workflow information can be performed by the MFP 20 (an information acquiring apparatus), and some of remaining processes can be performed by the workflow server 30.

For example, when five processes have been defined in the workflow information as shown in FIG. 2, the MFP 20 performs the first process (filtering), the second process (top-bottom discrimination), and the third process (image correction). Then, the workflow server 30 performs the fourth process (OCR) and the fifth process (delivery). In this case, in between processes of which the executing body is switched, target data and the workflow information are transferred from the MFP 20 (an information acquiring apparatus) to the workflow server 30.

Alternatively, in the information processing system 10, all of the multiple processes defined in the workflow information can be performed by either the MFP 20 (an information acquiring apparatus) or the workflow server 30. When all of the multiple processes are performed by the workflow server 30, before execution of the multiple processes, target data acquired by the MFP 20 (an information acquiring apparatus) and the workflow information are transferred from the MFP 20 (an information acquiring apparatus) to the workflow server 30.

The multiple processes defined in the workflow information here may include a process (a specific process) to be definitely performed by the workflow server 30. If the multiple processes defined in the workflow information include such a process, there is described in the workflow information that the defined multiple processes include the process to be definitely performed by the workflow server 30. Instead of this or in addition to this, whether each of the defined multiple processes is a process to be definitely performed by the workflow server 30 can be described in the workflow information.

When a process to be performed by the workflow server 30 exists in the workflow information, before the process to be performed by the workflow server 30, the MFP 20 (an information acquiring apparatus) transmits target data to the workflow server 30. Then, the workflow server 30 receives the target data, and performs the process to be performed by the workflow server 30 and subsequent processes in the multiple processes defined in the workflow information.

Consequently, according to the information processing system 10, either the MFP 20 (an information acquiring apparatus) or the workflow server 30 can perform the multiple processes defined in the workflow information. Furthermore, according to the information processing system 10, it is possible to cause the workflow server 30 to perform a process to be performed by the workflow server 30.

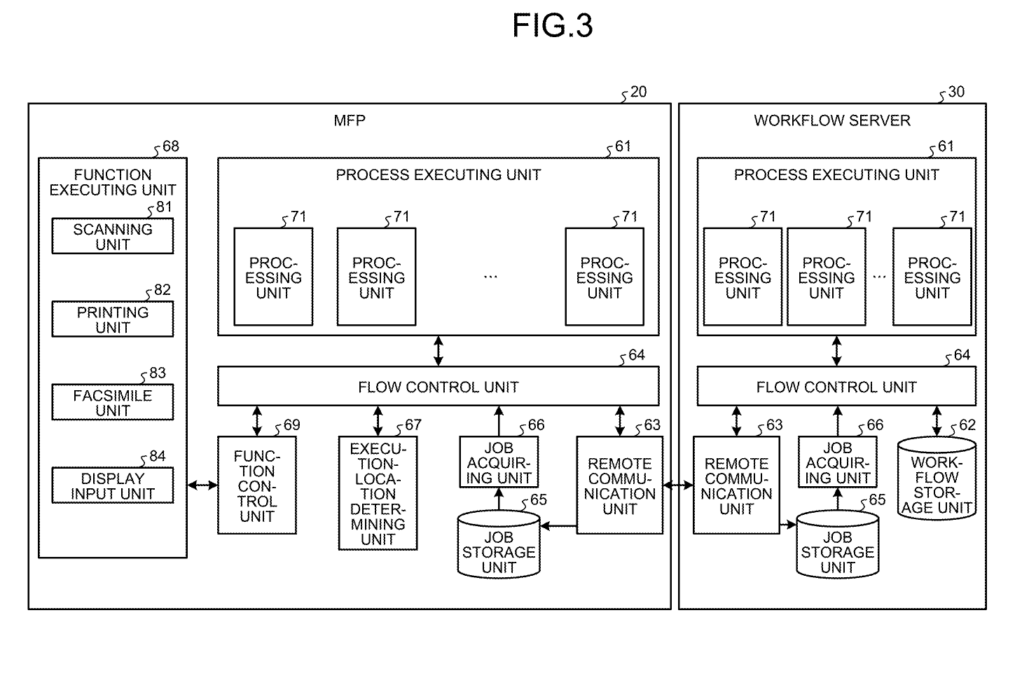

FIG. 3 is a diagram showing functional configurations of the MFP 20 and the workflow server 30. The workflow server 30 includes a process executing unit 61, a workflow storage unit 62, a remote communication unit 63, a flow control unit 64, a job storage unit 65, and a job acquiring unit 66.

The process executing unit 61 executes processes defined in workflow information. The process executing unit 61 includes a plurality of processing units 71. The processing units 71 execute different processes from one another. Each of the processing units 71 is realized by a processor executing a plug-in program called by the flow control unit 64.

For example, a plug-in program for character recognition has been pre-installed in the process executing unit 61, and, when the plug-in program for character recognition has been called, the process executing unit 61 performs a character recognition (OCR) process.

Furthermore, for example, a plug-in program for mail delivery has been pre-installed in the process executing unit 61, and, when the plug-in program for mail delivery has been called, the process executing unit 61 performs a mail delivery process.

The workflow storage unit 62 stores therein at least one piece of workflow information registered by an administrator or the like. The remote communication unit 63 communicates with the MFP 20 and other devices via the network 40.

The flow control unit 64 controls the order of executing multiple processes executed by the process executing unit 61 in accordance with workflow information. More specifically, the flow control unit 64 receives selection of workflow information from the MFP 20 through the remote communication unit 63, and reads out the selected workflow information from the workflow storage unit 62. The flow control unit 64 transmits the read workflow information to the MFP 20 through the remote communication unit 63. Then, when the flow control unit 64 has received target data from the MFP 20 through the remote communication unit 63, the flow control unit 64 causes the process executing unit 61 to execute processes defined in the workflow information.

Furthermore, the remote communication unit 63 receives a job, which is an instruction to execute a workflow, from the MFP 20 or another device via the network 40. The job storage unit 65 temporarily stores therein the job received by the remote communication unit 63. The job acquiring unit 66 acquires the job stored in the job storage unit 65 according to the availability of resources of the process executing unit 61, and passes the acquired job to the flow control unit 64. The flow control unit 64 controls execution of processes in accordance with workflow information indicated in the job received from the job acquiring unit 66.

The MFP 20 includes the process executing unit 61, the remote communication unit 63, the flow control unit 64, the job storage unit 65, the job acquiring unit 66, an execution-location determining unit 67, a function executing unit 68, and a function control unit 69.

The process executing unit 61, the remote communication unit 63, and the flow control unit 64 of the MFP 20 have the same function and configuration as those of the workflow server 30. However, the flow control unit 64 of the MFP 20 acquires workflow information from the workflow server 30 through the remote communication unit 63.

Furthermore, the process executing unit 61 of the MFP 20 can differ in content of an executable process from the process executing unit 61 of the workflow server 30. That is, the process executing unit 61 of the MFP 20 can register a different kind of plug-in program from that registered in the process executing unit 61 of the workflow server 30.

The remote communication unit 63 of the MFP 20 receives a job which is a process execution instruction including workflow information, etc. from the workflow server 30 via the network 40. The job storage unit 65 of the MFP 20 temporarily stores therein the received job. The job acquiring unit 66 of the MFP 20 acquires the job stored in the job storage unit 65 according to the availability of resources of the process executing unit 61 of the MFP 20, and passes the acquired job to the flow control unit 64. The flow control unit 64 of the MFP 20 controls execution of processes in accordance with the workflow information included in the job received from the job acquiring unit 66.

The execution-location determining unit 67 determines either the workflow server 30 or the MFP 20 should execute processes defined in workflow information. When the execution-location determining unit 67 has determined that the workflow server 30 should execute processes defined in workflow information, the execution-location determining unit 67 causes target data and the workflow information to be transmitted to the workflow server 30 through the remote communication unit 63.

The function executing unit 68 executes unique functions that the MFP 20 has. As an example, the function executing unit 68 includes a scanning unit 81, a printing unit 82, a facsimile unit 83, and a display input unit 84.

The scanning unit 81 scans a sheet set on a platen, thereby acquiring image data. The printing unit 82 prints an image on a sheet. The facsimile unit 83 sends or receives a facsimile through a telephone line. The display input unit 84 displays information to a user, and receives operation information from a user.

The function control unit 69 controls a function executed by the function executing unit 68. When a process executed by the function executing unit 68 is defined in workflow information, the function control unit 69 causes the function executing unit 68 to execute the process in response to a call from the flow control unit 64.

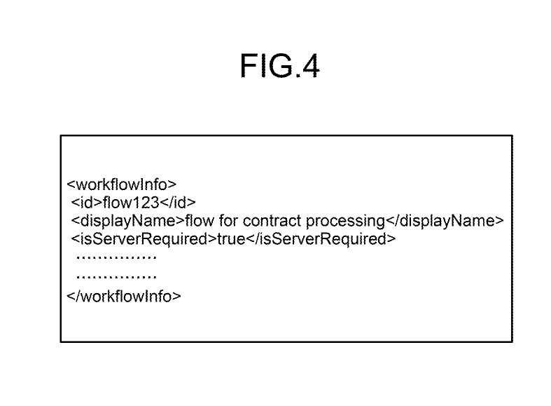

FIG. 4 is a diagram showing an example of setting information included in workflow information. For example, information shown in FIG. 4 is described in workflow information.

In the workflow information shown in FIG. 4, “<isServerRequired>” and “</isServerRequired>” tags are described. In between these tags, “true” or “false” is described. In the case of true, it indicates that a process to be performed by the workflow server 30 is included in defined multiple processes. In the case of false, it indicates that a process to be performed by the workflow server 30 is not included in defined multiple processes.

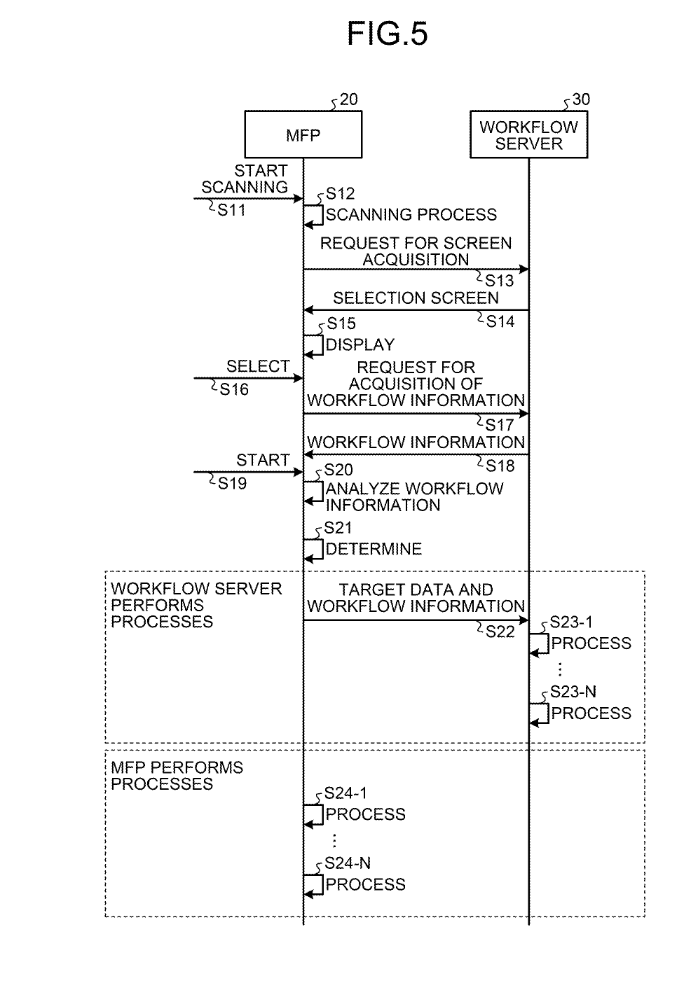

FIG. 5 is a diagram showing a sequence of workflow execution. When executing a workflow, the MFP 20 and the workflow server 30 proceed with processing, for example, in the sequence shown in FIG. 5.

First, at Step S11, a user instructs the MFP 20 to start scanning. when the MFP 20 receives the instruction to start scanning, then at Step S12, the MFP 20 performs a scanning process, and acquires image data (target data) by scanning a sheet.

Incidentally, here we describe an example where the MFP 20 acquires image data; however, another device can acquire data. For example, an image pickup device can acquire still image data or moving image data. Furthermore, the client terminal 21 can receive a mail, or can read out data from a recording medium. Moreover, an electronic blackboard can read handwritten information.

Then, at Step S13, the MFP 20 transmits a request for acquisition of a workflow selection screen to the workflow server 30. Then, at Step S14, the workflow server 30 transmits the workflow selection screen to the MFP 20. Then, at Step S15, the MFP 20 displays thereon the acquired workflow selection screen.

Then, at Step S16, the user performs a workflow selection operation on the MFP 20. When the selection operation has been performed, at Step S17, the MFP 20 transmits a request for acquisition of workflow information corresponding to the workflow selected by the user to the workflow server 30. Then, at Step S18, the workflow server 30 transmits the corresponding workflow information to the MFP 20.

Then, at Step S19, the user issues an instruction to start execution of the workflow to the MFP 20. Upon receipt of the instruction to start execution, at Step S20, the MFP 20 analyzes the workflow information. Specifically, the MFP 20 analyzes information described in between the “<isServerRequired>” and “</isServerRequired>” tags shown in FIG. 4. Then, at Step S21, the MFP 20 determines whether multiple processes defined in the workflow information include a process to be performed by the workflow server 30.

When the MFP 20 has determined that multiple processes defined in the workflow information include a process to be performed by the workflow server 30, the MFP 20 causes the workflow server 30 to perform the process. When the workflow server 30 performs the process, at Step S22, the MFP 20 transmits the target data and the workflow information to the workflow server 30. Then, the workflow server 30 receives the target data and the workflow information. Then, at Steps S23-1 to S23-N, the workflow server 30 sequentially performs the multiple processes defined in the workflow information.

On the other hand, when the MFP 20 has determined that multiple processes defined in the workflow information do not include a process to be performed by the workflow server 30, the MFP 20 performs the processes. When the MFP 20 performs the processes, the MFP 20 does not transmit the target data, etc. to the workflow server 30. Then, at Steps S24-1 to S24-N, the MFP 20 sequentially performs the multiple processes defined in the workflow information.

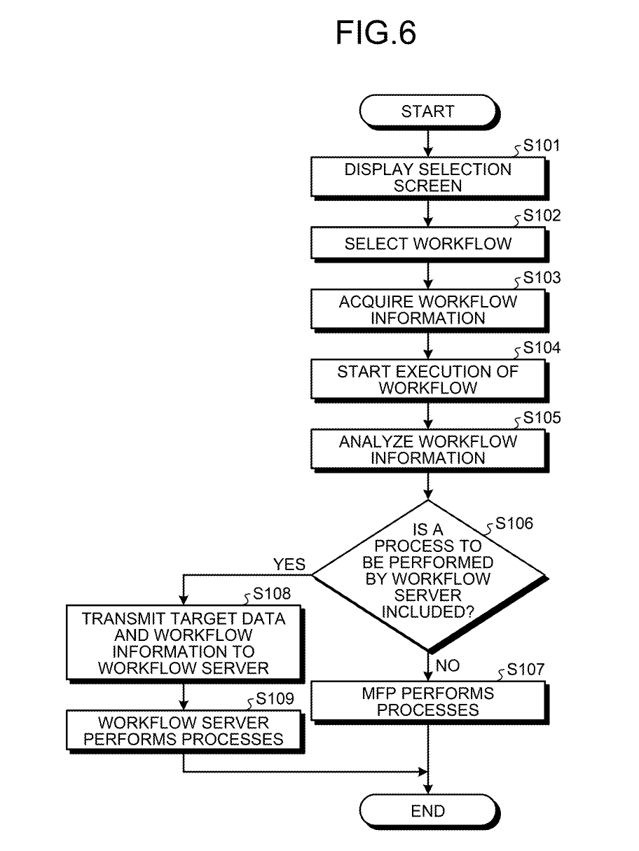

FIG. 6 is a flowchart in the case where first, an executing body is determined, and then a workflow is executed by the determined executing body. When the sequence shown in FIG. 5 is executed, the MFP 20 and the workflow server 30 execute the flow shown in FIG. 6.

First, at Step S101, the MFP 20 displays thereon a workflow selection screen. Then, at Step S102, the MFP 20 receives an operation performed on the selection screen, and selects a workflow to be executed.

Then, at Step S103, the MFP 20 acquires workflow information of the selected workflow from the workflow server 30. Then, at Step S104, the MFP 20 starts execution of the workflow in response to an operation performed by a user.

When the MFP 20 has started execution of the workflow, first, at Step S105, the MFP 20 analyzes the workflow information. Then, at Step S106, the MFP 20 determines whether multiple processes defined in the workflow information include a process to be performed by the workflow server 30 on the basis of a result of the analysis.

When multiple processes defined in the workflow information do not include a process to be performed by the workflow server 30 (NO at Step S106), the MFP 20 proceeds to Step S107. At Step S107, the MFP 20 sequentially performs all the multiple processes defined in the workflow information. Then, when the MFP 20 has performed the final process, the flow is terminated.

When multiple processes defined in the workflow information include even one process to be performed by the workflow server 30 (YES at Step S106), the MFP 20 proceeds to Step S108. At Step S108, the MFP 20 transmits target data and the workflow information to the workflow server 30. Then, at Step S109, the workflow server 30 sequentially performs all the multiple processes defined in the workflow information on the basis of the received target data and workflow information. Then, when the workflow server 30 has performed the final process, the flow is terminated.

As described above, before execution of multiple processes defined in workflow information, the MFP 20 determines whether the multiple processes include a process to be performed by the workflow server 30, and, when the multiple processes include a process to be performed by the workflow server 30, the MFP 20 transmits target data to the workflow server 30. Then, the workflow server 30 performs the multiple processes defined in the workflow information from the beginning. Consequently, according to the information processing system 10, it is possible to cause the workflow server 30 to perform the process to be performed by the workflow server 30.

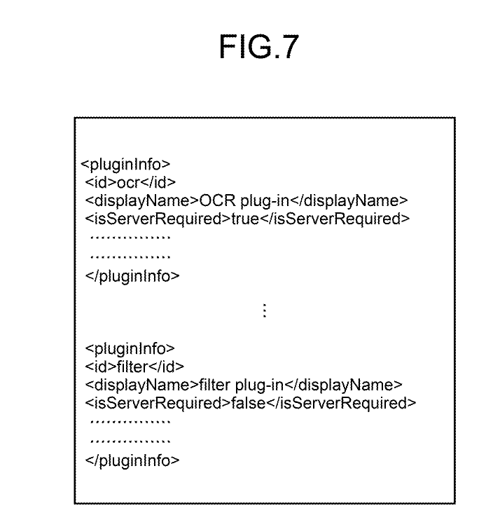

FIG. 7 is a diagram showing an example of setting information (plug-in information) of each process included in workflow information. In the workflow information, for example, the setting information shown in FIG. 7 is described with respect to each of defined multiple processes.

In the workflow information shown in FIG. 7, “<pluginInfo>” and “</pluginInfo>” tags are described. In between these tags, information set with respect to one process (plug-in) is described.

Furthermore, “<isServerRequired>” and “</isServerRequired>” tags are described in between the “<pluginInfo>” and “</pluginInfo>” tags. In between the “<isServerRequired>” and “</isServerRequired>” tags, “true” or “false” is described. In the case of true, it indicates that a corresponding process is a process to be performed by the workflow server 30. In the case of false, it indicates that a corresponding process is not a process to be performed by the workflow server 30 (i.e., a corresponding process can be performed by either the workflow server 30 or another device).

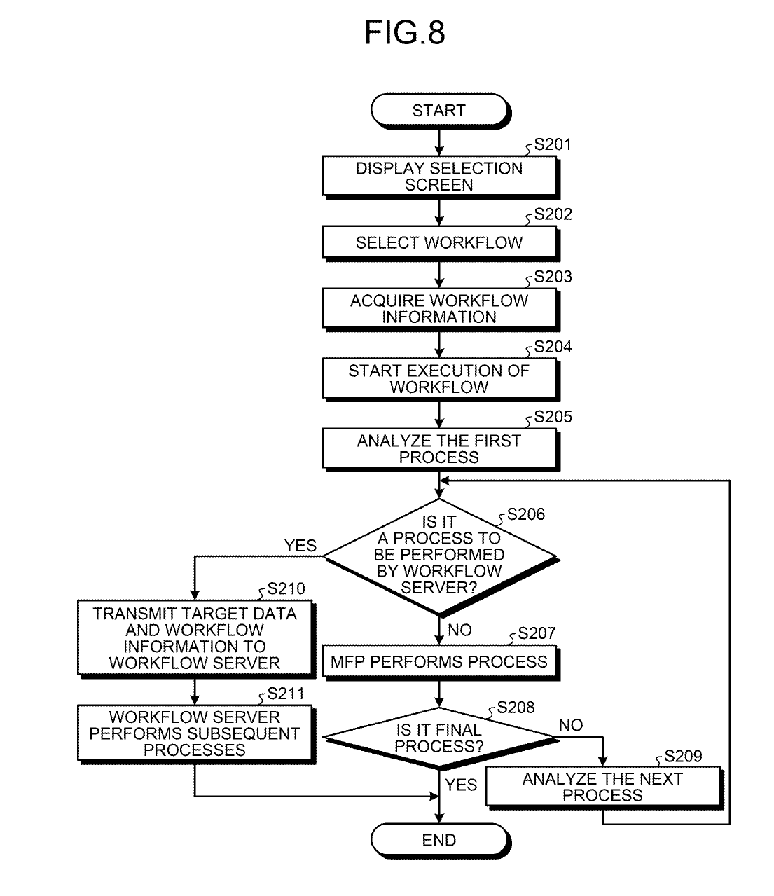

FIG. 8 is a flowchart in the case where an executing body is determined with respect to each process, and a workflow is executed by the determined executing body. When whether each of multiple processes is a process to be performed by the workflow server 30 is described in workflow information as shown in FIG. 7, the MFP 20 and the workflow server 30 execute the flowchart shown in FIG. 8.

First, at Steps S201 to S204, the MFP 20 performs the same processing as Steps S101 to S104 in FIG. 6.

When the MFP 20 has started execution of a workflow, at Step S205, the MFP 20 analyzes setting information (plug-in information) of the first process with reference to workflow information. Specifically, the MFP 20 analyzes information described in between “<isServerRequired>” and “</isServerRequired>” tags included in between “<pluginInfo>” and “</pluginInfo>” tags for the corresponding process as shown in FIG. 7. Then, at Step S206, the MFP 20 determines whether the process is a process to be performed by the workflow server 30.

When the process is not a process to be performed by the workflow server 30 (NO at Step S206), the MFP 20 proceeds to Step S207. Then, at Step S207, the MFP 20 performs the process. Then, at Step S208, the MFP 20 determines whether the process is the final process.

When the process is the final process (YES at Step S208), the MFP 20 terminates the flow. When the process is not the final process (NO at Step S208), then, at Step S209, the MFP 20 analyzes setting information (plug-in information) of the next process with reference to the workflow information. After Step S209, the MFP 20 goes back to Step S206 and determines whether the next process is a process to be performed by the workflow server 30.

When the process is a process to be performed by the workflow server 30 (YES at Step S206), the MFP 20 proceeds to Step S210. At Step S210, the MFP 20 transmits target data and the workflow information to the workflow server 30. The target data here is data obtained through execution of processes prior to the process.

Then, at Step S211, the workflow server 30 sequentially performs the process and subsequent processes on the basis of the received target data and workflow information. Then, when the workflow server 30 has performed the final process, the flow is terminated.

As described above, with respect to each of multiple processes defined in workflow information, the MFP 20 determines whether the process is to be performed by the workflow server 30. Then, when all the processes are not a process to be performed by the workflow server 30, the MFP 20 performs all the processes. When there is a process to be performed by the workflow server 30, the MFP 20 performs processes immediately prior to the process to be performed by the workflow server 30, and then transmits target data to the workflow server 30. Then, the workflow server 30 performs the process to be performed by the workflow server 30 and subsequent processes. Consequently, according to the information processing system 10, it is possible to cause the workflow server 30 to perform a process to be performed by the workflow server 30.

Incidentally, after the workflow server 30 has received the target data and the workflow information from the MFP 20, when the workflow server 30 performs a process not to be performed by the workflow server 30, the workflow server 30 can transmit the target data and the workflow information to the MFP 20 again. In this case, the MFP 20 again repeats the processing from Step S206 and performs the process and subsequent processes. Accordingly, the MFP 20 and the workflow server 30 can perform the multiple processes defined in the workflow information while switching the executing body with respect to each process. However, in this case, for example, when traffic of the network 40 is congested and it takes long for the MFP 20 and the workflow server 30 to process the workflow, it is preferable that the workflow server 30 completes the processes without sending the target data, etc. back to the MFP 20.

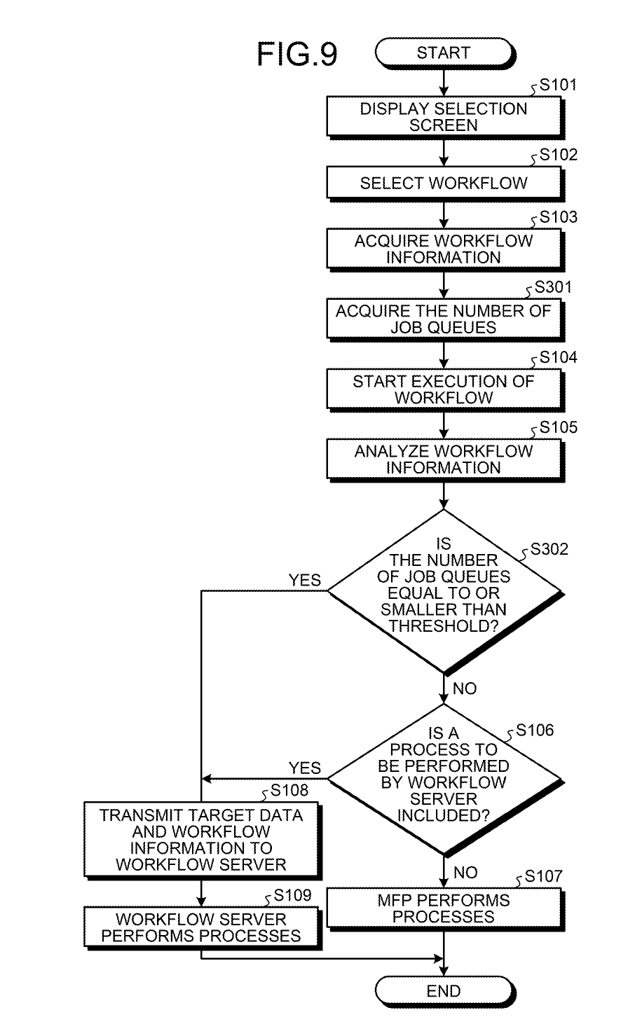

FIG. 9 is a flowchart in the case where first, an executing body is determined on the basis of the number of job queues, and then a workflow is executed by the determined executing body. The MFP 20 and the workflow server 30 can execute the flow shown in FIG. 9. Incidentally, the flow shown in FIG. 9 is substantially same as that shown in FIG. 6, so description of the flow other than differences from the flow shown in FIG. 6 is omitted.

After Step S103, the MFP 20 executes processing at Step S301. At Step S301, the MFP 20 acquires the number of job queues from the workflow server 30. The number of job queues indicates the number of not-yet-executed jobs held in the workflow server 30. Therefore, the larger the number of job queues, the higher the processing load of the workflow server 30; that is, the smaller the number of job queues, the lower the processing load of the workflow server 30. After the completion of Step S301, the MFP 20 proceeds to Step S104.

After Step S105, at Step S302, the MFP 20 determines whether the acquired number of job queues is equal to or smaller than a threshold. That is, the MFP 20 determines whether a processing load of the workflow server 30 is equal to or lower than a predetermined value.

When the acquired number of job queues is equal to or smaller than the threshold (YES at Step S302), the MFP 20 proceeds to Step S108. When the acquired number of job queues is not equal to or smaller than the threshold (NO at Step S302), the MFP 20 proceeds to Step S106.

As described above, when the number of job queues in the workflow server 30 is equal to or smaller than the threshold (i.e., when a processing load of the workflow server 30 is equal to or lower than the predetermined value), the MFP 20 transmits acquired data to the workflow server 30. Consequently, according to the information processing system 10, regardless of whether multiple processes defined in workflow information include a process to be performed by the workflow server 30, it is possible to cause the workflow server 30 to execute a workflow if a processing load of the workflow server 30 is low.

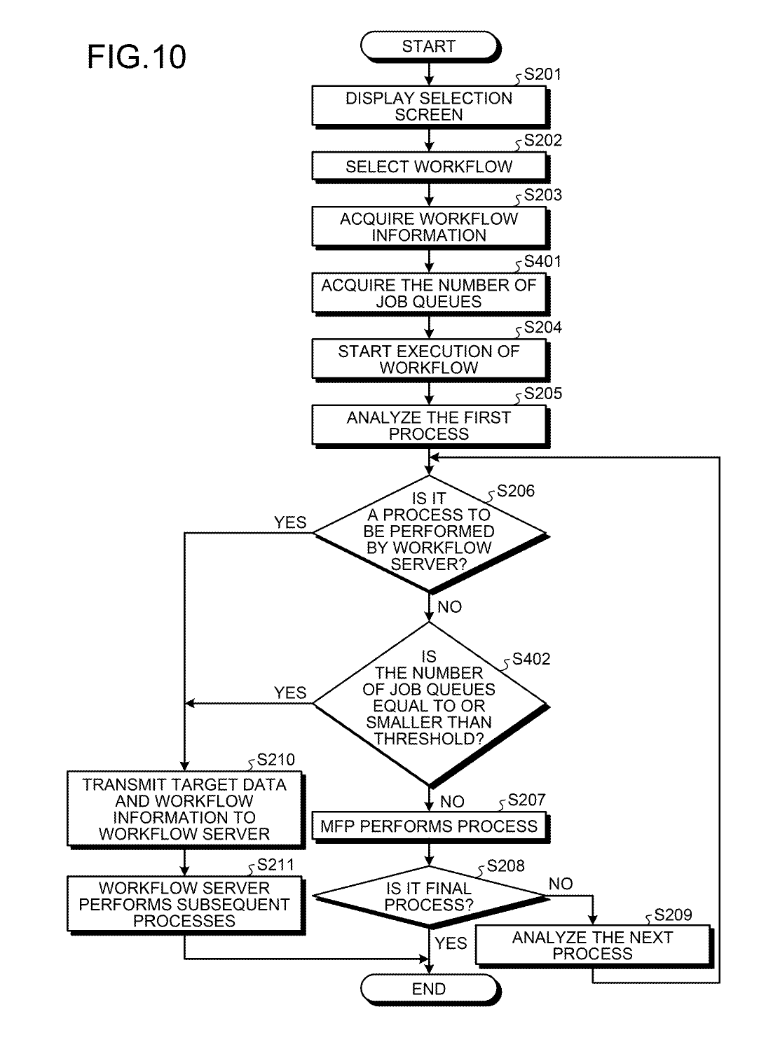

FIG. 10 is a flowchart in the case where an executing body is determined on the basis of the number of job queues with respect to each process, and a workflow is executed by the determined executing body. The MFP 20 and the workflow server 30 can execute the flow shown in FIG. 10. Incidentally, the flow shown in FIG. 10 is substantially same as that shown in FIG. 8, so description of the flow other than differences from the flow shown in FIG. 8 is omitted.

After Step S203, the MFP 20 executes processing at Step S401. At Step S401, the MFP 20 acquires the number of job queues from the workflow server 30. Then, after the completion of Step S401, the MFP 20 proceeds to Step S204.

At Step S206, when the MFP 20 has determined that the process is not a process to be performed by the workflow server 30 (NO at Step S206), the MFP 20 proceeds to Step S402. At Step S402, the MFP 20 determines whether the acquired number of job queues is equal to or smaller than a threshold. That is, the MFP 20 determines whether a processing load of the workflow server 30 is equal to or lower than a predetermined value.

When the acquired number of job queues is equal to or smaller than the threshold (YES at Step S402), the MFP 20 proceeds to Step S210. When the acquired number of job queues is not equal to or smaller than the threshold (NO at Step S402), the MFP 20 proceeds to Step S207.

As described above, with respect to each of multiple processes, the MFP 20 determines whether the number of job queues in the workflow server 30 is equal to or smaller than the threshold. Then, when the number of job queues in the workflow server 30 is equal to or smaller than the threshold (i.e., when a processing load of the workflow server 30 is equal to or lower than the predetermined value), the MFP 20 transmits acquired data to the workflow server 30. On the other hand, when the number of job queues in the workflow server 30 is not equal to or smaller than the threshold (i.e., when a processing load of the workflow server 30 is not equal to or lower than the predetermined value), the MFP 20 performs the process.

Consequently, according to the information processing system 10, regardless of whether a process is to be performed by the workflow server 30, it is possible to cause the workflow server 30 to perform the process if a processing load of the workflow server 30 is low.

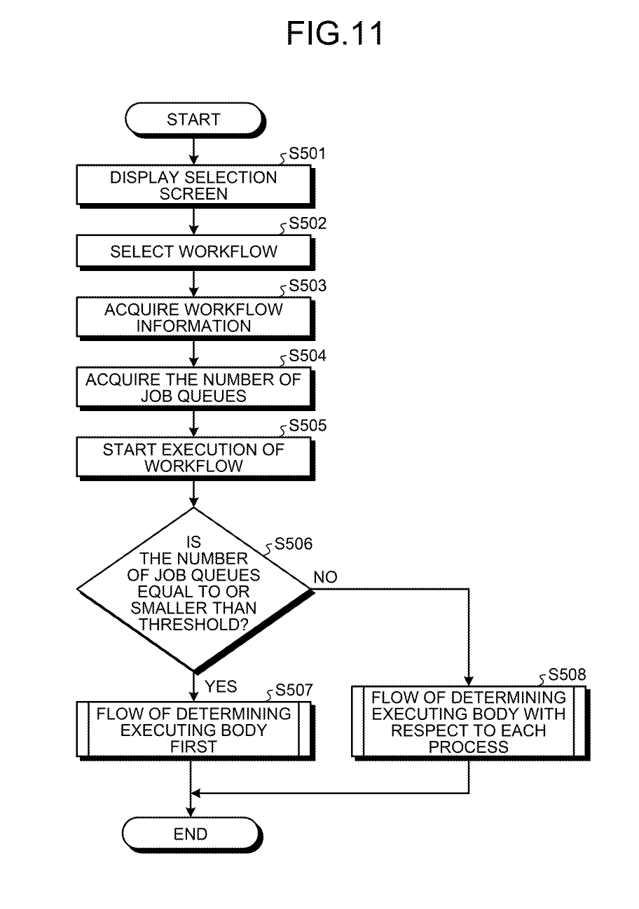

FIG. 11 is a flowchart in the case of switching to either to execute a flow of determining an executing body first or to execute a flow of determining an executing body with respect to each process on the basis of the number of job queues. The MFP 20 and the workflow server 30 can execute the flow shown in FIG. 11.

First, at Steps S501 to S503, the MFP 20 performs the same processing as Steps S101 to S103 in FIG. 6. Then, at Step S504, the MFP 20 acquires the number of job queues from the workflow server 30.

Then, at Step S505, the MFP 20 starts execution of a workflow in response to an operation performed by a user. When the MFP 20 has started execution of the workflow, at Step S506, the MFP 20 determines whether the acquired number of job queues is equal to or smaller than a threshold. That is, the MFP 20 determines whether a processing load of the workflow server 30 is equal to or lower than a predetermined value.

When the acquired number of job queues is equal to or smaller than the threshold (YES at Step S506), the MFP 20 proceeds to Step S507.

At Step S507, the MFP 20 and the workflow server 30 perform the same processing as Steps S105 to S109 in FIG. 6. That is, at Step S507, the MFP 20 and the workflow server 30 perform a flow of determining either the MFP 20 or the workflow server to be an executing body before performing multiple processes defined in workflow information.

On the other hand, when the acquired number of job queues is not equal to or smaller than the threshold (NO at Step S506), the MFP 20 proceeds to Step S508.

At Step S508, the MFP 20 and the workflow server 30 perform the same processing as Steps S205 to S211 in FIG. 8. That is, at Step S508, the MFP 20 and the workflow server 30 perform a flow of determining either the MFP 20 or the workflow server 30 to be an executing body with respect to each of multiple processes defined in workflow information.

Consequently, according to the information processing system 10, if a processing load of the workflow server 30 is low, it is possible to cause the workflow server 30 to perform multiple processes defined in workflow information. Then, according to the information processing system 10, if a processing load of the workflow server 30 is not low, with respect to each process, whether the process is to be performed by the workflow server 30 is determined, and if the process is to be performed by the workflow server 30, it is possible to cause the workflow server 30 to perform the process and subsequent processes.

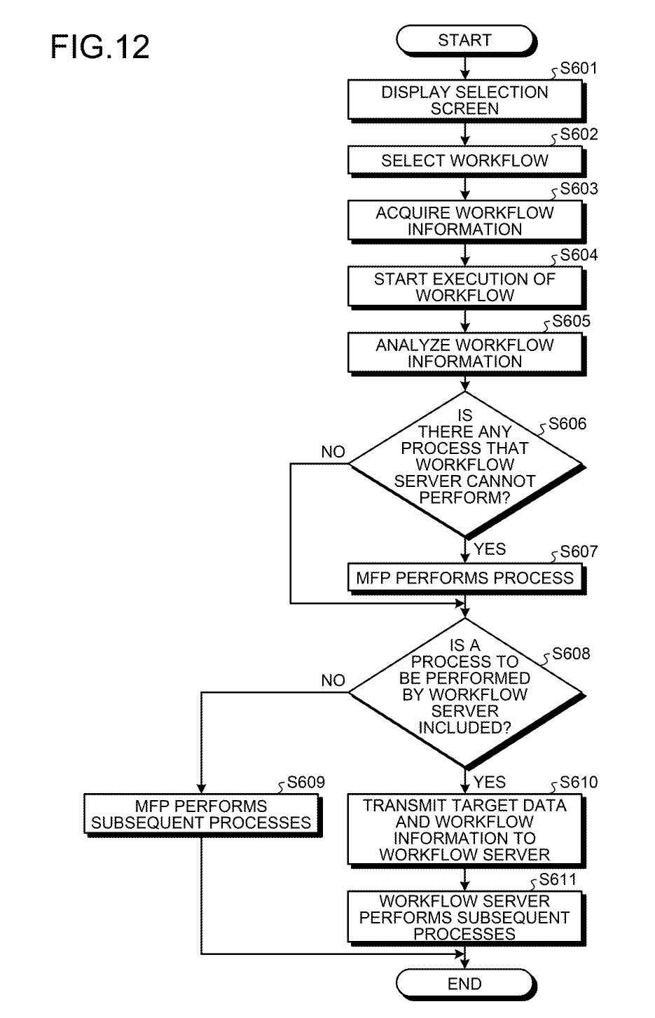

FIG. 12 is a flowchart in the case of executing a workflow including a process that the workflow server 30 cannot perform. Workflow information can define, for example, a scanning process, an image pickup process, and a voice acquiring process, etc. as a data acquiring process. When such processes using unique functions of an information acquiring apparatus are defined in workflow information, the workflow server 30 cannot perform the processes. Therefore, in such a case, the MFP 20 and the workflow server 30 execute the flow shown in FIG. 12.

First, at Steps S601 to S604, the MFP 20 performs the same processing as Steps S101 to S104 in FIG. 6.

When the MFP 20 has started execution of the workflow, at Step S605, the MFP 20 analyzes the workflow information. Then, at Step S606, the MFP 20 determines whether a data acquiring process that the workflow server 30 cannot perform is defined on the basis of a result of the analysis of the workflow information. For example, the MFP 20 determines whether a scanning process is defined in the workflow information.

When a process that the workflow server 30 cannot perform is defined in the workflow information (YES at Step S606), the MFP 20 proceeds to Step S607. When no process that the workflow server 30 cannot perform is defined in the workflow information (NO at Step S606), the MFP 20 proceeds to Step S608.

At Step S607, the MFP 20 performs the process (the data acquiring process that the workflow server 30 cannot perform). After the completion of Step S607, the MFP 20 proceeds to Step S608.

Then, at Steps S608 to S611, the MFP 20 and the workflow server 30 perform the same processing as Steps S106 to S109 in FIG. 6.

Consequently, according to the information processing system 10, even if a data acquiring process that the workflow server 30 cannot perform is defined in the beginning of workflow information, processes defined in the workflow information can be performed certainly.

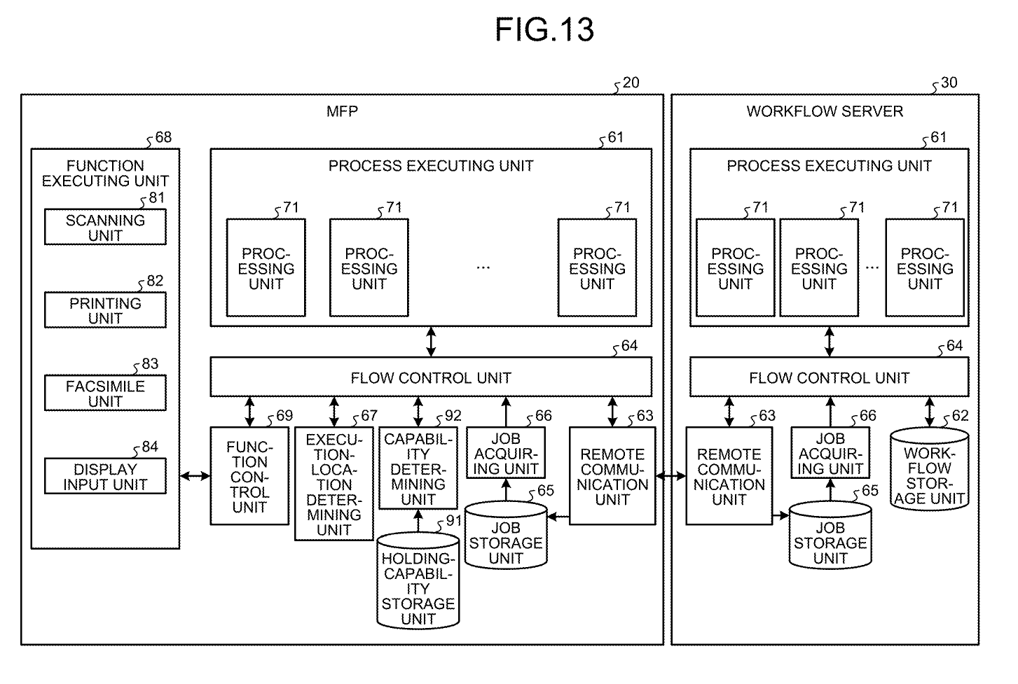

FIG. 13 is a diagram showing functional configurations of the MFP 20 and the workflow server 30 which are included in the information processing system 10 according to a variant.

The information processing system 10 according to the variant has about the same functions and configuration as the information processing system 10 shown in FIG. 3, so the same functional block is assigned the same reference numeral, and description of the configuration other than differences from that shown in FIG. 3 is omitted.

The MFP 20 according to the variation further includes a holding-capability storage unit 91 and a capability determining unit 92. The holding-capability storage unit 91 stores therein hardware and software capability that the MFP 20 has.

For example, the holding-capability storage unit 91 stores therein the clock speed, memory size, hard disk capacity, and communication interface version, etc. of a processor included in the MFP 20. Furthermore, the holding-capability storage unit 91 stores therein contents of methods, libraries, or programs, etc. installed in the MFP 20.

The capability determining unit 92 determines whether the holding capability stored in the holding-capability storage unit 91 meets required capability required for execution of multiple processes defined in workflow information.

The required capability required for execution of multiple processes defined in workflow information is described in the workflow information. The required capability includes, for example, the clock speed, memory size, hard disk capacity, and communication interface version, etc. of a processor which are required of an apparatus that performs the processes. Furthermore, the required capability includes methods, libraries, or programs, etc. installed in the apparatus that performs the processes.

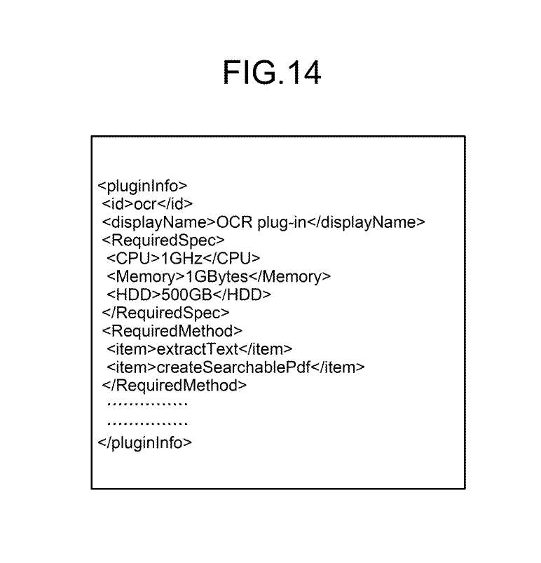

FIG. 14 is a diagram showing an example of setting information (plug-in information) of each process included in workflow information. In the workflow information according to the variant, for example, the setting information shown in FIG. 14 is described with respect to each of defined multiple processes.

In the workflow information shown in FIG. 14, “<pluginInfo>” and “</pluginInfo>” tags are described. In between these tags, information set with respect to one process (plug-in) is described.

Furthermore, “<RequiredSpec>” and “</RequiredSpec>” tags are described in between the “<pluginInfo>” and “</pluginInfo>” tags. In between the “<RequiredSpec>” and “</RequiredSpec>” tags, for example, the clock speed, memory size, hard disk capacity, and communication interface version, etc. of a processor, which are required of an apparatus that performs the processes, are described.

Moreover, “<RequiredMethod>” and “</RequiredMethod>” tags are described in between the “<pluginInfo>” and “</pluginInfo>” tags. In between the “<RequiredMethod>” and “</RequiredMethod>” tags, for example, methods, libraries, or programs, etc. which have to be installed in an apparatus to perform the processes are described.

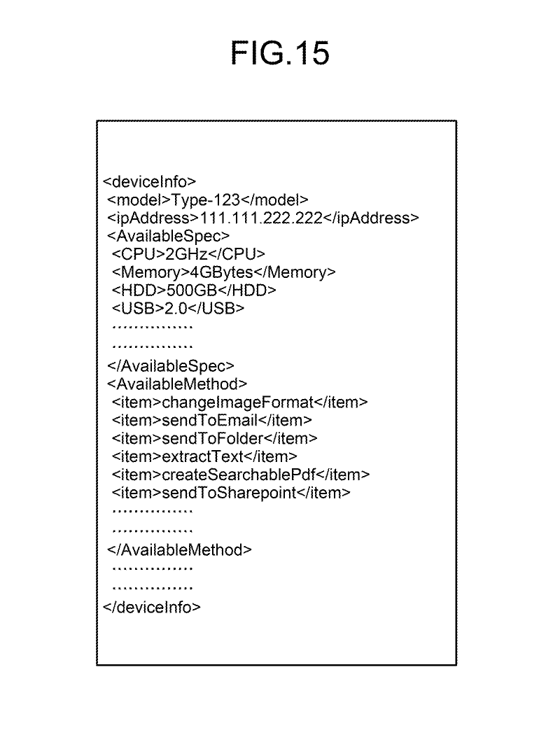

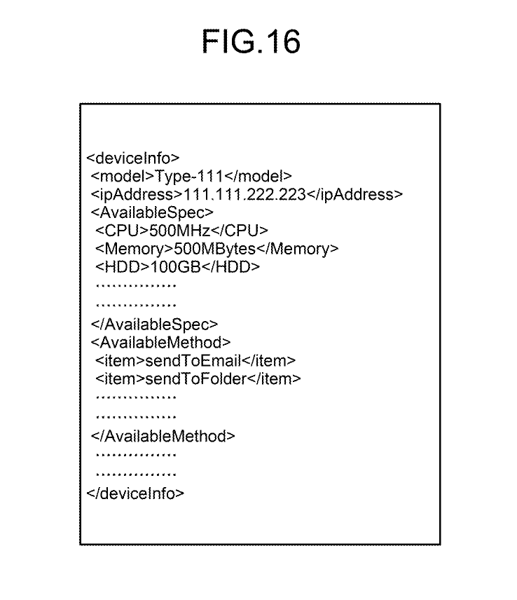

FIG. 15 is a diagram showing an example of device information indicating capability that an apparatus has. FIG. 16 is a diagram showing another example of device information indicating capability that an apparatus has.

The holding-capability storage unit 91 stores therein holding capability information written in the form of an XML document as shown in FIGS. 15 and 16 as an example.

As shown in FIGS. 15 and 16, “<AvailableSpec>” and “</AvailableSpec>” tags are described in the holding capability information. In between the “<AvailableSpec>” and “</AvailableSpec>” tags, capability of a hardware device (for example, the clock speed, memory size, hard disk capacity, and communication interface version, etc. of a processor) held by the apparatus is described.

Furthermore, “<AvailableMethod>” and “</AvailableMethod>” tags are described in the holding capability information. In between the “<AvailableMethod>” and “</AvailableMethod>” tags, methods, libraries, or programs, etc. installed in the apparatus are described.

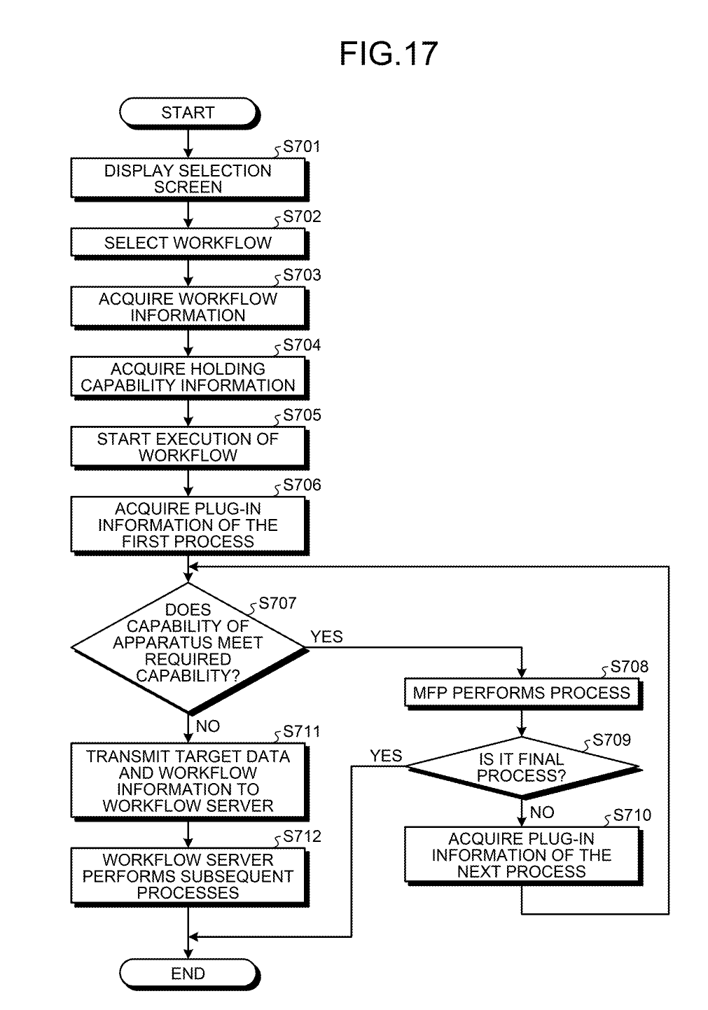

FIG. 17 is a flowchart in the case where in the information processing system 10 according to the variant, an executing body is determined with respect to each process, and a workflow is executed. When executing a workflow, the MFP 20 and the workflow server 30 according to the variant execute, for example, the flow shown in FIG. 17.

First, at Step S701, the MFP 20 displays thereon a workflow selection screen. Then, at Step S702, the MFP 20 receives an operation performed on the selection screen, and selects a workflow to be executed.

Then, at Step S703, the MFP 20 acquires workflow information of the selected workflow from the workflow server 30. Then, at Step S704, the MFP 20 acquires holding capability information. Specifically, the MFP 20 acquires an XML document like those shown in FIGS. 15 and 16. Then, at Step S705, the MFP 20 starts execution of the workflow in response to an operation performed by a user.

When the MFP 20 has started execution of the workflow, at Step S706, the MFP 20 analyzes setting information (plug-in information) of the first process with reference to the workflow information. Specifically, the MFP 20 analyzes information described in between “<RequiredSpec>” and “</RequiredSpec>” tags included in between “<pluginInfo>” and “</pluginInfo>” tags for the corresponding process shown in FIG. 14.

Then, at Step S707, the MFP 20 determines whether capability of the MFP 20 meets capability required for execution of the process. When capability of the MFP 20 meets capability required for execution of the process (YES at Step S707), the MFP 20 proceeds to Step S708. Then, at Step S708, the MFP 20 performs the process. Then, at Step S709, the MFP 20 determines whether the process is the final process.

When the process is the final process (YES at Step S709), the MFP 20 terminates the flow. When the process is not the final process (NO at Step S709), then, at Step S710, the MFP 20 analyzes setting information (plug-in information) of the next process with reference to the workflow information. After Step S710, the MFP 20 goes back to Step S707 and determines whether the capability of the MFP 20 meets capability required for execution of the next process.

When the capability of the MFP 20 does not meet capability required for execution of the process (NO at Step S707), the MFP 20 proceeds to Step S711. At Step S711, the MFP 20 transmits target data and the workflow information to the workflow server 30. The target data here is data obtained through execution of processes prior to the process.

Then, the workflow server 30 sequentially performs the process and subsequent processes on the basis of the received target data and workflow information. Then, when the workflow server 30 has performed the final process, the flow is terminated.

As described above, with respect to each of multiple processes defined in workflow information, the MFP 20 determines whether capability of the MFP 20 meets capability required for execution of a process. Then, when the capability of the MFP 20 meets capability required for execution of all the processes, the MFP 20 performs all the processes. When there is a process requiring capability that the capability of the MFP 20 does not meet, the MFP 20 performs processes prior to the process, and then transmits target data to the workflow server 30. Then, the workflow server 30 performs the process requiring capability that the capability of the MFP 20 does not meet and subsequent processes. Consequently, according to the information processing system 10, it is possible to cause the workflow server 30 to perform a process requiring capability that the capability of the MFP 20 does not meet.

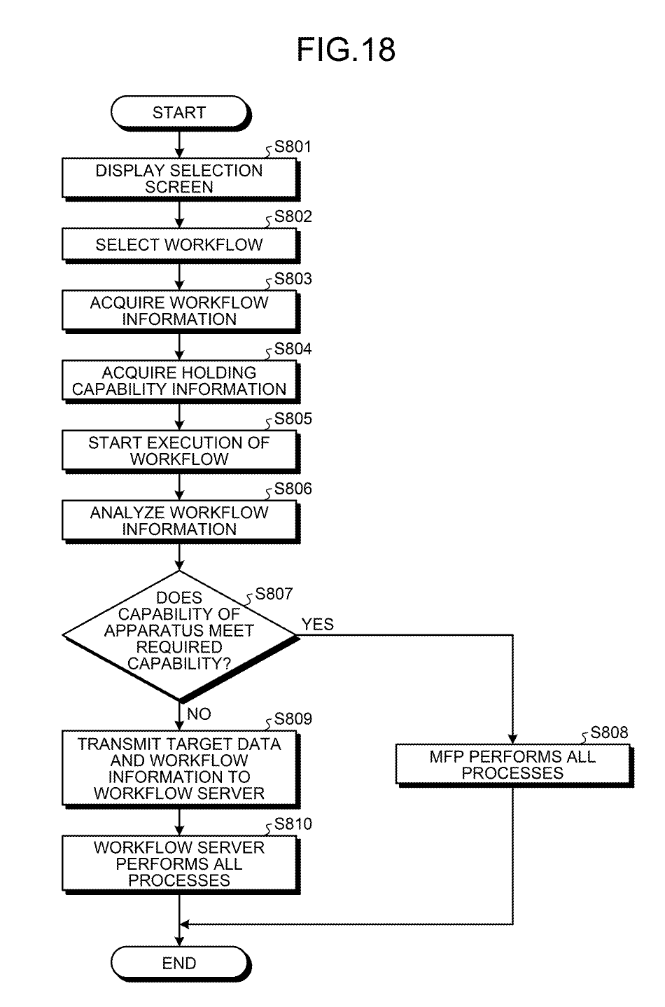

FIG. 18 is a flowchart in the case where in the information processing system 10 according to the variant, first, an executing body is determined, and then a workflow is executed. Instead of required capability for each process (each plug-in) like that shown in FIG. 14 or in addition to the required capability for each process, required capability required of an apparatus to perform overall multiple processes defined can be described in workflow information.

In this case, when executing a workflow, the MFP 20 and the workflow server 30 according to the variant proceed with processing in the flow shown in FIG. 18.

First, at Steps S801 to S805, the MFP 20 performs the same processing as Steps S701 to S705 in FIG. 17.

When the MFP 20 has started execution of the workflow, at Step S806, the MFP 20 analyzes setting information with reference to the workflow information. Then, at Step S807, the MFP 20 determines whether capability of the MFP 20 meets capability required for execution of all multiple processes defined in the workflow information on the basis of a result of the analysis.

When capability of the MFP 20 meets capability required for execution of all the multiple processes (YES at Step S807), the MFP 20 proceeds to Step S808. At Step S808, the MFP 20 sequentially performs all the multiple processes defined in the workflow information. Then, when the MFP 20 has performed the final process, the flow is terminated.

On the other hand, when capability of the MFP 20 does not meet capability required for execution of all the multiple processes (NO at Step S807), the MFP 20 proceeds to Step S809. At Step S809, the MFP 20 transmits target data and the workflow information to the workflow server 30. Then, at Step S810, the workflow server 30 sequentially performs all the multiple processes defined in the workflow information on the basis of the received target data and workflow information. Then, when the workflow server 30 has performed the final process, the flow is terminated.

As described above, before execution of multiple processes defined in workflow information, the MFP 20 determines whether capability of the MFP 20 meets capability required for execution of all the multiple processes, and, when capability of the MFP 20 does not meet capability required for execution of all the multiple processes, the MFP 20 transmits target data to the workflow server 30. Then, the workflow server 30 performs the multiple processes defined in the workflow information from the beginning. Consequently, according to the information processing system 10, it is possible to cause the workflow server 30 to perform multiple processes requiring capability that the capability of the MFP 20 does not meet.

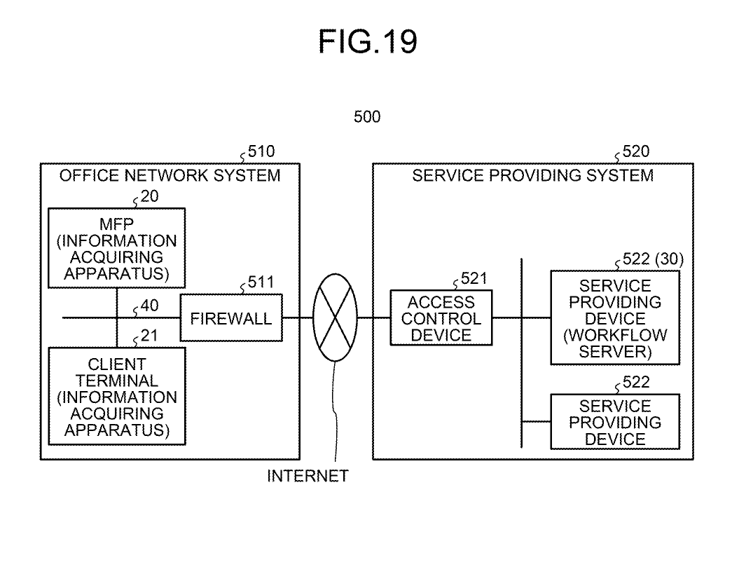

FIG. 19 is a diagram showing a configuration in which the information processing system 10 according to the embodiment is applied to a cloud system 500.

The information processing system 10 according to the present embodiment can be applied to the cloud system 500. The cloud system 500 includes, as an example, an office network system 510 and a service providing system 520. The office network system 510 and the service providing system 520 are connected via the Internet.

In the office network system 510, the MFP 20 and the client terminal 21 are connected via the network 40. Furthermore, the apparatuses in the office network system 510 are connected to an external server or the like through a firewall 511. Therefore, the MFP 20 or the like can access the external server or the like; however, the MFP 20 or the like is not directly accessed from the server or the like.

The service providing system 520 includes multiple service providing devices 522. The multiple service providing devices 522 can be composed of a plurality of information processing apparatuses, or can be composed of one information processing apparatus.

One of the service providing devices 522 provides the functions of the workflow server 30 in the information processing system 10 to the MFP 20 or the like in the office network system 510.

An access control device 521 authenticates the MFP 20 or the like in the office network system 510 to determine whether or not to allow the MFP 20 or the like to access to the service providing system 520. In the authentication for access to the service providing system 520, for example, a code called organization code uniquely assigned to a company is used. When an apparatus in the office network system 510 has been successfully authenticated by the access control device 521, the apparatus can access the service providing devices 522.

According to the cloud system 500, the workflow server 30 does not have to be installed in the office network system 510; therefore, the functions of the workflow server 30 can be achieved without installing an expensive server.

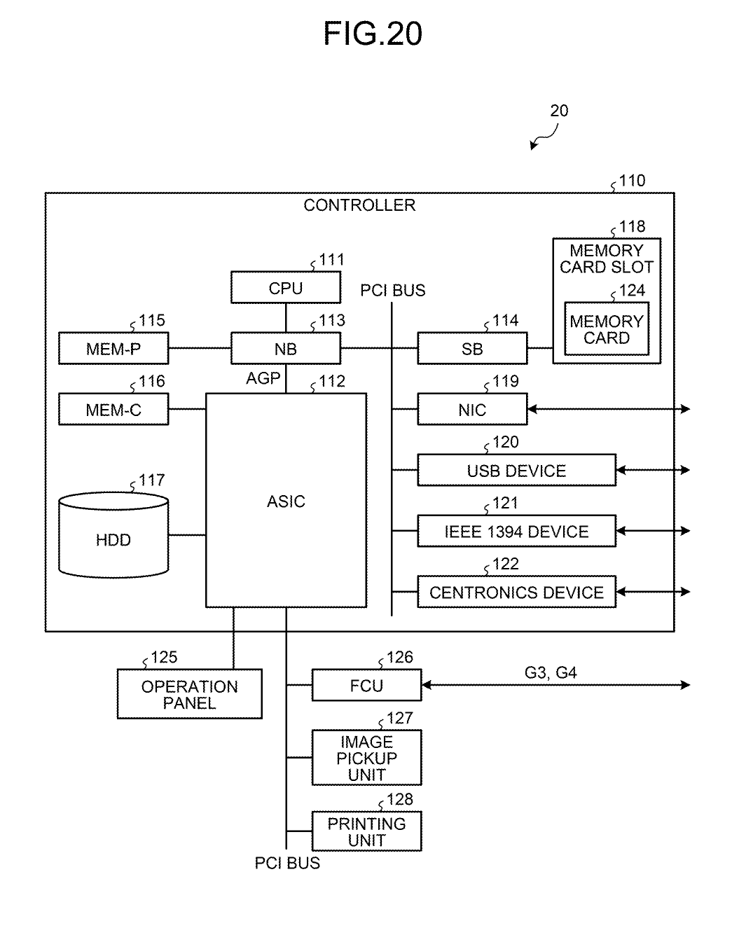

FIG. 20 is a diagram showing an example of a hardware configuration of the MFP 20. The MFP 20 includes, as an example, a controller 110, an operation panel 125, a facsimile control unit (FCU) 126, an image pickup unit 127, and a printing unit 128.

The controller 110 includes a central processing unit (CPU) 111, an application specific integrated circuit (ASIC) 112, a Northbridge (NB) 113, a Southbridge (SB) 114, a system memory (MEM-P) 115, a local memory (MEM-C) 116, a hard disk drive (HDD) 117, a memory card slot 118, a network interface controller (NIC) 119, a USB device 120, an IEEE 1394 device 121, and a Centronics device 122.

The CPU 111 is an IC for executing various information processing, and executes applications in parallel in process units on an operating system (OS) or a platform. The ASIC 112 is a semiconductor device for image processing. The NB 113 is a bridge for connecting the CPU 111 and the ASIC 112. The SB 114 is a bridge for connecting the NB 113 and a peripheral device. The ASIC 112 and the NB 113 are connected through, for example, an accelerated graphics port (AGP).

The MEM-P 115 is a memory connected to the NB 113. The MEM-C 116 is a memory connected to the ASIC 112. The HDD 117 is storage connected to the ASIC 112, and is used for image data storage, document data storage, program storage, font data storage, and form data storage, etc.

In the HDD 117, various application programs (a copy program, a scanner program, a printer program, and a fax program, etc.) have been stored. Furthermore, various plug-in programs have been stored in the HDD 117. The plug-in programs are programs for executing various processes defined in workflow information. These programs are files in an installable or executable format. Moreover, a workflow processing program has been stored in the HDD 117. The workflow processing program is a program to analyze workflow information, call a necessary plug-in program, and execute processes according to the workflow information.

The memory card slot 118 is connected to the SB 114, and is used to set (insert) a memory card 124. The memory card 124 is a flash memory such as a USB memory, and is used to distribute the workflow processing program and the plug-in programs. The workflow processing program and the plug-in programs can be distributed by being downloaded from a given server to the MFP 20.

The NIC 119 is a controller for performing data communication using a MAC address or the like via the network 40, etc. The USB device 120 is a device for providing a serial port based on the universal serial bus (USB) standards. The IEEE 1394 device 121 is a device for providing a serial port based on the IEEE 1394 standards. The Centronics device 122 is a device for providing a parallel port based on the Centronics specification. The NIC 119, the USB device 120, the IEEE 1394 device 121, and the Centronics device 122 are connected to the NB 113 and the SB 114 through a peripheral component interconnect (PCI) bus.

The operation panel 125 is hardware (an operation unit) through which a user performs input to the MFP 20, and also is hardware (a display unit) on which the MFP 20 displays a menu screen. The operation panel 125 is connected to the ASIC 112. The FCU 126, the image pickup unit 127, and the printing unit 128 are connected to the ASIC 112 through the PCI bus.

The image pickup unit 127 optically scans an original set on a platen glass, and converts a reflected light from analog to digital and performs image processing, thereby generating color or black-and-white image data.

The printing unit 128 includes, for example, tandem photosensitive drums, and modulates laser beams on the basis of image data or page description language (PDL) data received from the client terminal 21 or the like and scans the photosensitive drums with modulated laser beams to form latent images on the photosensitive drums. Then, the printing unit 128 transfers an image of each page, which has been obtained by transfer of toners to the latent images, onto a sheet by application of heat and pressure. The printing unit 128 is not limited to such an electrophotographic plotter, and can be an ink-jet plotter engine that forms an image by discharging ink droplets.

The FCU 126 is connected to the network 40 through the NIC 119 in a communication procedure based on, for example, T.37 and T.38 standards or connected to a public telecommunication network in a communication procedure based on, for example, G3 and G4 standards, and transmits and receives image data. Furthermore, even when the FCU 126 has received image data while the MFP 20 is powered off, the FCU 126 can activate the printing unit 128 and cause the printing unit 128 to print the image data on a sheet.

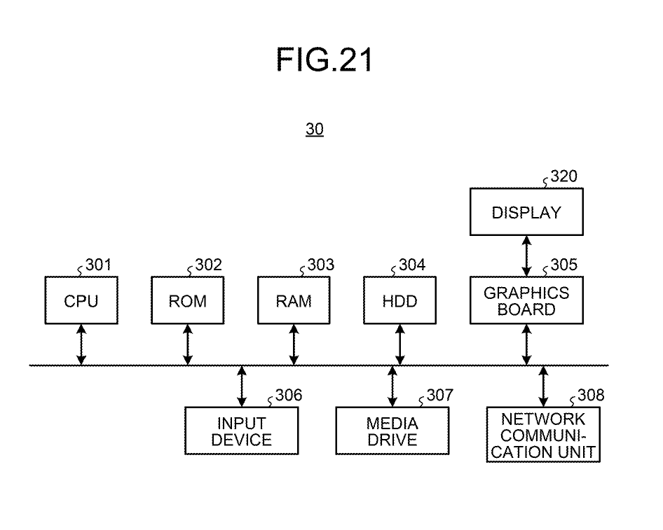

FIG. 21 is a diagram showing an example of a hardware configuration of the workflow server 30.

The workflow server 30 includes a CPU 301, a read-only memory (ROM) 302, a random access memory (RAM) 303, an HDD 304, a graphics board 305 connected to a display 320, an input device 306, a media drive 307, and a network communication unit 308. The CPU 301, the ROM 302, the RAM 303, the HDD 304, the graphics board 305, the input device 306, the media drive 307, and the network communication unit 308 are connected by a bus.

The CPU 301 expands a program stored in the HDD 304 into the RAM 303 and executes the program, and inputs/outputs data and performs data processing by controlling components. A start program for loading a basic input/output system (BIOS) and a bootstrap loader from the HDD 304 into the RAM 303 has been stored in the ROM 302. The bootstrap loader loads an OS from the HDD 304 into the RAM 303.

The HDD 304 can be any non-volatile memory; for example, the HDD 304 can be a solid state drive (SSD). The HDD 304 has stored therein the OS and a device driver. Furthermore, a workflow processing program has been stored in the HDD 304. Moreover, various plug-in programs have been stored in the HDD 304. These programs are files in an installable or executable format, and are recorded on computer-readable recording media and distributed. Furthermore, the programs can be distributed by causing a user to download the programs from a server.

On the display 320, a GUI screen created by the graphics board 305 in accordance with an instruction from a program is displayed. The input device 306 is, for example, a keyboard or a mouse, etc., and receives an operation performed by a user. The media drive 307 reads/writes data from/on optical recording media, such as a compact disk, a digital versatile disk (DVD), and a Blu-ray disk. Furthermore, the media drive 307 can read/write data from/on a memory card such as a flash memory. The network communication unit 308 is an Ethernet™ card for connecting to, for example, a LAN.

As described above, information processing apparatus (the MFP 20 and the workflow server 30, etc.) according to the present embodiment includes a control device such as a CPU, a storage device such as a ROM and a RAM, an external storage device such as an HDD and a CD drive device, a display device such as a display, and an input device such as a keyboard and a mouse, and has a hardware configuration using a general computer.

A program executed by the information processing apparatus according to the present embodiment is provided in such a manner that the program is recorded on a computer-readable recording medium, such as a CD-ROM, a flexible disk (FD), a CD-R, or a DVD, etc. in an installable or executable file format.

Furthermore, the program executed by the information processing apparatus according to the present embodiment can be stored on a computer connected to a network such as the Internet, and the program can be provided by causing a user to download it via the network. Moreover, the program executed by the information processing apparatus according to the present embodiment can be provided or distributed via a network such as the Internet. Furthermore, the program according to the present embodiment can be built into a ROM or the like in advance and provided.

The program executed by the information processing apparatus according to the present embodiment is composed of modules including the above-described units (the process executing unit 61 and the flow control unit 64), and a CPU (a processor) as actual hardware reads out the program from the storage medium and executes the program, thereby the above-described units are loaded onto main storage, and the process executing unit 61 and the flow control unit 64 are generated on the main storage.

According to the present invention, it is possible to perform multiple processes defined in workflow information efficiently.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

The present invention can be implemented in any convenient form, for example using dedicated hardware, or a mixture of dedicated hardware and software. The present invention may be implemented as computer software implemented by one or more network processing apparatus. The network can comprise any conventional terrestrial or wireless communications network, such as the Internet. The processing apparatus can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cashe memory of the CPU, and the RAM may function as a physical memory or a primary memory of the apparatus, while the HDD may function as a secondary memory of the apparatus.

What is claimed is:

1. An information processing system that comprises an information acquiring apparatus for acquiring data and a server and executes multiple processes defined in workflow information, wherein
the workflow information defines order of the multiple processes,
either the information acquiring apparatus or the server performs the multiple processes defined in the workflow information,
when a specific process is included in the multiple processes defined in the workflow information, the information acquiring apparatus transmits target data to the server before the specific process, and
the server receives the target data and performs the specific process out of the multiple processes defined in the workflow information.

2. The information processing system according to claim 1, wherein
when the multiple processes defined in the workflow information include a process to be performed by the server, the information acquiring apparatus transmits target data to the server before the process to be performed by the server, and
the server receives the target data and performs the process to be performed by the server out of the multiple processes defined in the workflow information.

3. The information processing system according to claim 2, wherein
there is described in the workflow information that a process to be performed by the server is included in the multiple processes defined therein,
before execution of the multiple processes defined in the workflow information, the information acquiring apparatus determines whether the multiple processes include a process to be performed by the server, and, when the multiple processes include a process to be performed by the server, transmits target data to the server, and
the server performs the multiple processes defined in the workflow information.

4. The information processing system according to claim 3, wherein
when a processing load of the server is equal to or lower than a predetermined value, the information acquiring apparatus transmits the target data to the server.

5. The information processing system according to claim 2, wherein
whether each of the multiple processes is a process to be performed by the server is described in the workflow information,
the information acquiring apparatus determines whether each of the multiple processes defined in the workflow information is a process to be performed by the server,
when a process is not a process to be performed by the server, the information acquiring apparatus performs the process, and
when a process is a process to be performed by the server, the information acquiring apparatus transmits target data to the server, and the server performs the process to be performed by the server.

6. The information processing system according to claim 5, wherein
even when the process is not a process to be performed by the server, if a processing load of the server is equal to or lower than the predetermined value, the information acquiring apparatus transmits the target data to the server.

7. The information processing system according to claim 2, wherein
the information acquiring apparatus determines whether the workflow information includes a process that the server cannot perform, and
when the workflow information includes a process that the server cannot perform, after the information acquiring apparatus performs at least the process that the server cannot perform, the information acquiring apparatus transmits target data to the server, and the server performs subsequent processes.

8. The information processing system according to claim 1, wherein
when a process requiring capability that capability of the apparatus does not meet is included in the multiple processes defined in the workflow information, the information acquiring apparatus transmits target data to the server before the process requiring capability that capability of the apparatus does not meet, and
the server receives the target data and performs the process requiring capability that capability of the information acquiring apparatus does not meet out of the multiple processes defined in the workflow information.

9. The information processing system according to claim 8, wherein
capability required of the apparatus to perform the defined multiple processes is described in the workflow information,
before execution of the multiple processes defined in the workflow information, the information acquiring apparatus determines whether capability of the apparatus meets the required capability, and
when the multiple processes include a process requiring capability that the capability of the apparatus does not meet, the information acquiring apparatus transmits the acquired data to the server, and the server performs the multiple processes defined in the workflow information.

10. The information processing system according to claim 8, wherein
capability required of the apparatus to perform each of the multiple processes is described in the workflow information,
with respect to each of the multiple processes defined in the workflow information, the information acquiring apparatus determines whether capability of the apparatus meets capability required for execution of a process,
when the capability of the apparatus meets the required capability, the information acquiring apparatus performs the process, and
when the capability of the apparatus does not meet the required capability, the information acquiring apparatus transmits target data to the server, and the server performs the process requiring the capability that the capability of the apparatus does not meet and subsequent processes.

11. An information processing method employed in an information processing system that includes an information acquiring apparatus for acquiring data and a server and executes multiple processes defined in workflow information, the workflow information defining order of the multiple processes, the method comprising:
performing, at either the information acquiring apparatus or the server, the multiple processes defined in the workflow information, wherein the performing further includes;
transmitting, at the information acquiring apparatus, target data to the server before the specific process, when a specific process is included in the multiple processes defined in the workflow information;
receiving, at the server, the target data; and
performing, at the server, the specific process out of the multiple processes defined in the workflow information.

12. The method according to claim 11, wherein
the transmitting includes transmitting, at the information acquiring apparatus, target data to the server before the process to be performed by the server, when the multiple processes defined in the workflow information include a process to be performed by the server,
the receiving includes receiving, at the server, the target data, and
the performing includes performing, at the server, the process to be performed by the server out of the multiple processes defined in the workflow information.

13. The method according to claim 12, further comprising:
determining, at the information acquiring apparatus, whether the multiple processes include a process to be performed by the server, before execution of the multiple processes defined in the workflow information, wherein
there is described in the workflow information that a process to be performed by the server is included in the multiple processes defined therein,
the transmitting includes transmitting, at the information acquiring apparatus, target data to the server, when the multiple processes include a process to be performed by the server, and
the performing includes performing, at the server, the multiple processes defined in the workflow information.

14. The method according to claim 13, wherein
the transmitting includes transmitting, at the information acquiring apparatus, the target data to the server, when a processing load of the server is equal to or lower than a predetermined value.

15. The method according to claim 12, further comprising:
determining, at the information acquiring apparatus, whether each of the multiple processes defined in the workflow information is a process to be performed by the server, wherein
whether each of the multiple processes is a process to be performed by the server is described in the workflow information,
the performing includes performing, at the information acquiring apparatus, the process, when a process is not a process to be performed by the server,
the transmitting includes transmitting, at the information acquiring apparatus, target data to the server, when a process is a process to be performed by the server, and
the performing includes performing, at the server, the process to be performed by the server.

16. The method according to claim 15, wherein
the transmitting includes transmitting, at the information acquiring apparatus, the target data to the server even when the process is not a process to be performed by the server, if a processing load of the server is equal to or lower than the predetermined value.

17. The method according to claim 12, further comprising:
determining, at the information acquiring apparatus, whether the workflow information includes a process that the server cannot perform, wherein
the performing includes performing, at the information acquiring apparatus, at least the process that the server cannot perform, when the workflow information includes a process that the server cannot perform,
the transmitting includes transmitting, at the information acquiring apparatus, target data to the server, and
the performing includes performing, at the server, subsequent processes.

18. The method according to claim 11, wherein
the transmitting include transmitting, at the information acquiring apparatus, target data to the server before the process requiring capability that capability of the apparatus does not meet, when a process requiring capability that capability of the apparatus does not meet is included in the multiple processes defined in the workflow information; and
the receiving includes receiving, at the server, the target data; and
the performing includes performing, at the server, the process requiring capability that capability of the information acquiring apparatus does not meet out of the multiple processes defined in the workflow information.

19. The method according to claim 18, further comprising:
determining, at the information acquiring apparatus, whether capability of the apparatus meets the required capability, before execution of the multiple processes defined in the workflow information, wherein
capability required of the apparatus to perform the defined multiple processes is described in the workflow information,
the transmitting includes transmitting, at the information acquiring apparatus, the acquired data to the server when the multiple processes include a process requiring capability that the capability of the apparatus does not meet, and
the performing includes performing, at the server, the multiple processes defined in the workflow information.

20. The method according to claim 18, further comprising:
determining, at the information acquiring apparatus, whether capability of the apparatus meets capability required for execution of a process with respect to each of the multiple processes defined in the workflow information, wherein
capability required of the apparatus to perform each of the multiple processes is described in the workflow information,
the performing includes performing, at the information acquiring apparatus, the process when the capability of the apparatus meets the required capability, and
the transmitting includes transmitting, at the information acquiring apparatus, target data to the server, when the capability of the apparatus does not meet the required capability, and
the performing includes performing, at the server, the process requiring the capability that the capability of the apparatus does not meet and subsequent processes.
